(19) United States
(12) Patent Application Publication
(10) Pub. No.: US 2013/0124000 A1
(43) Pub. Date: May 16, 2013

(54) POWER CONTROL NETWORK SYSTEM, POWER CONTROL METHOD, AND POWER CONTROLLER

(71) Applicants: Taku Matsumoto, Osaka-shi (JP); Hironori Kanbara, Osaka-shi (JP); Misuzu Doi, Osaka-shi (JP); Kazumasa Honda, Osaka-shi (JP); Azusa Umemoto, Osaka-shi (JP); Mitsunori Nojima, Osaka-shi (JP); Yohhei Iwami, Osaki-shi (JP); Kohtaroh Saitoh, Osaka-shi (JP)

(72) Inventors: Taku Matsumoto, Osaka-shi (JP); Hironori Kanbara, Osaka-shi (JP); Misuzu Doi, Osaka-shi (JP); Kazumasa Honda, Osaka-shi (JP); Azusa Umemoto, Osaka-shi (JP); Mitsunori Nojima, Osaka-shi (JP); Yohhei Iwami, Osaki-shi (JP); Kohtaroh Saitoh, Osaka-shi (JP)

(73) Assignee: SHARP KABUSHIKI KAISHA, Osaka-shi, Osaka (JP)

(21) Appl. No.: 13/810,778

(22) PCT Filed: Jul. 21, 2011
(86) PCT No.: PCT/JP2011/066537

§ 371 Date: Jan. 17, 2013

(30) Foreign Application Priority Data
Jul. 23, 2010 (JP) 2010-165846

(51) Int. Cl. G06F 1/32

(52) U.S. Cl. CPC G06F 1/3212
USPC 700/295

(57) ABSTRACT

When power failure occurs at a power grid, a controller obtains information related to an operating state of a plurality of electrical appliances; restrict an operation of at least some of electrical appliances currently operating among the plurality of electrical appliances, such that power consumption of the plurality of electric appliances does not exceed a first upper limit during a period in which the remaining amount in a storage battery is below a first threshold value; and restrict an operation of at least some of electrical appliances currently operating among the plurality of electrical appliances, such that power consumption of the plurality of electric appliances does not exceed a second upper limit during a period in which the remaining amount in the storage battery is greater than or equal to a first threshold value and below a second threshold value that is larger than the first threshold value.

### TECHNICAL FIELD

The present invention relates to the art of a power control network system including a storage battery, a plurality of electric appliances for operating by utilizing electric power from at least one of a power grid and the storage battery, and a controller.

### BACKGROUND ART

There are known a solar power generation device arranged at a residence or the like, a storage battery for storing electric power from the solar power generation device, a plurality of home appliances for operating by utilizing electric power from a power grid and storage battery, and a controller for controlling such devices.

For example, Japanese Patent Laying-Open No. 2008-283741 (PTL 1) discloses a power control system. According to Japanese Patent Laying-Open No. 2008-283741 (PTL 1), a system cooperative device includes a voltage detector for detecting occurrence of power failure; a control unit for generating, when occurrence of power failure is detected by the voltage detector, a disconnection signal for disconnecting a specific branch breaker that is a predetermined branch breaker that does not require power supply; and a communication unit transmitting the disconnection signal to the branch breaker. The branch breaker responds to reception of a disconnection signal to suppress supply of power supplied from the system cooperative device to a subordinate load device connected thereto when the branch breaker itself is the specific branch breaker, and supplies electric power supplied from the system cooperative device to a subordinate load device connected thereto when the branch breaker is not said specific branch breaker.

Japanese Patent Laying-Open No. 2010-16999 (PTL 2) discloses a power supply device for premises. According to Japanese Patent Laying-Open No. 2010-16999 (PTL 2), a solar power generation device and a power storage device are provided at the premises. A central processing unit is provided at the central control station that monitors the premises. At the premises, a detector for detecting management data including the illumination level in the premises, the temperature of refrigerator/freezer facilities, and the amount of power consumption, and a control unit gathering the measured data from each detector to execute control on the facility at the premises are provided. The data collected at the control unit is transmitted to said central control station through a transmission channel.

### CITATION LIST

### Patent Literature

PTL 1: Japanese Patent Laying-Open No. 2008-283741

PTL 2: Japanese Patent Laying-Open No. 2010-16999

### SUMMARY OF INVENTION

### Technical Problem

At residences and establishments where a plurality of home appliances can utilize electric power from a storage battery, it is not necessary to stop the operation of all electric appliances when power failure occurs at the power grid. However, if all electric appliances are operated as usual despite the event of power failure, the electric power stored in the storage battery will be depleted in a short period of time.

The present invention is directed to solving such a problem. An object of the present invention is to provide a power control network system that can utilize electric power stored in a storage battery efficiently for the operation of an electric appliance when power failure occurs at a power grid, a power control method, and a power controller.

### Solution to Problems

According to an aspect of the present invention, there is provided a power control network system including a storage battery, a plurality of electric appliances for operating by utilizing electric power from at least one of a power grid and storage battery, and a controller. The controller includes a communication interface for communicating with the storage battery and the plurality of electric appliances; and a processor. The processor is configured to: obtain, when power failure occurs at the power grid, a time when the power failure ends; determine whether a remaining amount in the storage battery is below a first threshold value; calculate, when the remaining amount in the storage battery is below the first threshold value, a first upper limit of power consumption of the plurality of electric appliances during a period in which the remaining amount in the storage battery is below the first threshold value such that the storage battery is not depleted before the time when the power failure ends; and restrict operation of at least some of the plurality of electric appliances through the communication interface such that power consumption of the plurality of electric appliances does not exceed the first upper limit during a period in which the remaining amount in the storage battery is below the first threshold value.

Preferably, the processor is configured to: determine whether the remaining amount in the storage battery is below a second threshold value that is larger than the first threshold value; and restrict the operation of at least some of the plurality of electric appliances through the communication interface such that the power consumption of the plurality of electric appliances does not exceed a predetermined second upper limit during a period in which the remaining amount in the storage battery is greater than or equal to the first threshold value and below the second threshold value.

Preferably, the processor is configured to: determine whether the remaining amount in the storage battery is below a second threshold value that is larger than the first threshold value; calculate, when the remaining amount in the storage battery is greater than or equal to the first threshold value and below the second threshold value, a second upper limit of power consumption of the plurality of electric appliances during a period in which the remaining amount in the storage battery is greater than or equal to the first threshold value and below the second threshold value such that said storage battery is depleted only after the time when power failure ends, and the first threshold value; and restrict the operation of at least some of the plurality of electric appliances through the communication interface such that power consumption of the plurality of electric appliances does not exceed the second upper limit during a period in which the remaining amount in the storage battery is greater than or equal to the first threshold value and below the second threshold value that is larger than the first threshold value. The second threshold value has a predetermined ratio to the first threshold value.

Preferably, the processor is configured to receive, through the communication interface, the time when power failure ends from an external server.

Preferably, the controller further includes an operation unit for accepting information from a user. The processor is configured to accept the time when power failure ends through the operation unit.

Preferably, the processor is configured to restrict, based on a predetermined priority level, the operation of at least some of the plurality of electric appliances by prohibiting in order the operation of an electric appliance having a lower priority level through the communication interface.

Preferably, the power control network system further includes a solar power generation unit. The storage battery stores electric power from the solar power generation unit.

According to another aspect of the present invention, there is provided a power control method at a network system including a storage battery, a plurality of electric appliances for operating by utilizing electric power from at least one of a power grid and storage battery, and a controller. The power control method includes the steps of:

obtaining, by the controller, when power failure occurs at the power grid, a time when the power failure ends; determining, by the controller, whether a remaining amount in the storage battery is below a first threshold value; calculating, by the controller, when the remaining amount in the storage battery is below the first threshold value, a first upper limit of power consumption of the plurality of electric appliances during a period in which the remaining amount in the storage battery is below the first threshold value such that the storage battery is not depleted before the time when the power failure ends; and restricting, by the controller, the operation of at least some of the plurality of electric appliances such that the power consumption of the plurality of electric appliances does not exceed the first upper limit during a period in which the remaining amount in the storage battery is below the first threshold value.

According to another aspect of the present invention, there is provided a power controller including a communication interface for communicating with a storage battery and a plurality of electric appliances for operating by utilizing electric power from at least one of a power grid and storage battery, and a processor. The processor is configured to: obtain, when power failure occurs at a power grid, a time when the power failure ends; determine whether a remaining amount in the storage battery is below a first threshold value; calculate, when the remaining amount in the storage battery is below the first threshold value, a first upper limit of power consumption of the plurality of electric appliances during a period in which the remaining amount in the storage battery is below the first threshold value such that the storage battery is not depleted before the time when the power failure ends; and restrict the operation of at least some of the plurality of electric appliances through the communication interface such that power consumption of the plurality of electric appliances does not exceed the first upper limit during a period in which the remaining amount in the storage battery is below the first threshold value.

According to another aspect of the present invention, there is provided a power control system including a storage battery; a plurality of electric appliances for operating by utilizing electric power from at least one of a power grid and storage battery; and a controller. The controller includes a communication interface for communicating with the storage battery and the plurality of electric appliances; and a processor. When power failure occurs at the power grid, the processor is configured to: determine whether the remaining amount in the storage battery is below a first threshold value, and whether the remaining amount in the storage battery is greater than or equal to the first threshold value and below a second threshold value that is larger than the first threshold value; restrict the operation of at least some of the plurality of electric appliances through the communication interface, such that power consumption of the plurality of electric appliances does not exceed a predetermined first upper limit during a period in which the remaining amount in the storage battery is below the first threshold value; and restrict the operation of at least some of the plurality of electric appliances through the communication interface such that the power consumption of the plurality of electric appliances does not exceed a predetermined second upper limit during a period in which the remaining amount in the storage battery is greater than or equal to the first threshold value and below a second threshold value that is larger than the first threshold value.

Preferably, the ratio of the second upper limit to the first upper limit is identical to the ratio of the second threshold value to the first threshold value.

Preferably, the ratio of the second upper limit to the first upper limit is greater than the ratio of the second threshold value to the first threshold value.

### Advantageous Effects of Invention

According to the present invention, there is provided a power control network system that can utilize electric power stored in a storage battery efficiently for the operation of an electric appliance when power failure occurs at a power grid, a power control method, and a power controller.

### BRIEF DESCRIPTION OF DRAWINGS

FIG. 1 is a pictorial representation of an entire configuration of a network system 1 according to an embodiment.

FIG. 2 is a block diagram representing a hardware configuration of a controller 100 according to a first embodiment.

FIG. 3 is a first pictorial representation of a power control table 101A according to the first embodiment.

FIG. 4 is a flowchart of the procedure in power control processing at controller 100 of the present embodiment.

FIG. 5 is a second pictorial representation of power control table 101A according to the first embodiment.

FIG. 6 is a third pictorial representation of power control table 101A according to the first embodiment.

FIG. 7 is a first pictorial representation of a power control table 101B according to an exemplified modification.

FIG. 8 is a flowchart of the procedure in power control processing at controller 100 according to the exemplified modification of the first embodiment.

FIG. 9 is a second pictorial representation of power control table 101B according to the exemplified modification.

FIG. 10 is a third pictorial representation of power control table 101B according to the exemplified modification.

FIG. 11 is a block diagram representing a hardware configuration of controller 100 according to a second embodiment.

FIG. 12 is a flowchart of the procedure in power control processing at controller 100 according to the second embodiment.

FIG. 13 is a flowchart of the procedure in power control processing at controller 100 according to an exemplified modification of the second embodiment.

### DESCRIPTION OF EMBODIMENTS

Embodiments of the present invention will be described hereinafter with reference to the drawings. In the following, the same elements have the same reference characters allotted. Their designation and function are also identical. Therefore, detailed description thereof will not be repeated.

### First Embodiment

<Operation Overview of Network System>

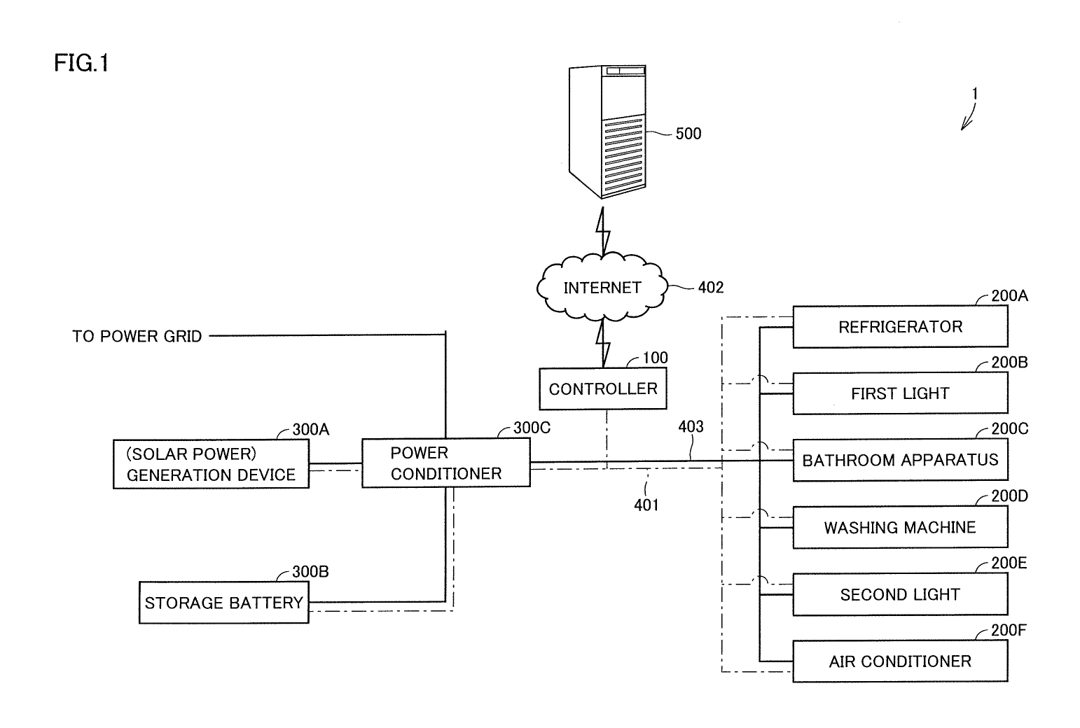

First, an operation overview of a network system according to the present embodiment will be described. FIG. 1 is a pictorial representation of an entire configuration of a network system 1 according to the present embodiment.

Referring to FIG. 1, network system 1 according to the present embodiment includes, for each residence, home appliances 200A-200F such as a refrigerator 200A installed in a kitchen, a first light 200B installed in a hallway, a bathroom apparatus 200C installed in a bathroom, a washing machine 200D installed in a washing room, a second light 200E installed in a living room, an air conditioner 200F installed in the living room and the like. Network system 1 further includes a solar power generation device 300A, a storage battery 300B storing electric power from solar power generation device 300A, and a power conditioner 300C for supplying electric power from at least one of solar power generation device 300A, storage battery 300B, and a power grid to home appliances 200A-200F. Home appliances 200A-200F and controller 100 obtain electric power from solar power generation device 300A, storage battery 300B, the power grid, and the like through a power line 403 and/or power conditioner 300C.

Controller 100 is capable of data communication with home appliances 200A-200F, solar power generation device 300A, storage battery 300B, and power conditioner 300C through a wired or wireless network 401. Controller 100 uses a wired LAN (Local Area Network), a wireless LAN, PLC (Power Line Communications), Bluetooth (registered trademark), or the like, for example, for network 401. Controller 100 may communicate with solar power generation device 300A and storage battery 300B through power conditioner 300C.

Network system 1 includes a server 500 capable of data communication with controller 100. Controller 100 uses the Internet, carrier network, WAN (Wide Area Network), LAN, Bluetooth (registered trademark) or the like, for example, for network 402. Network 401 and network 402 may use the same standard.

Server 500 according to the present embodiment transmits, through network 402, information associated with power failure (power failure starting time, power failure ending time, time before power failure ends, and the like) in response to a request from controller 100 at each residence, or automatically when power failure occurs. In other words, controller 100 at each residence can use, when power failure occurs at the power grid side, the electric power stored in storage battery 300B efficiently for the operation of a home appliance based on the power failure information from server 500.

A specific configuration of network system 1 to implement the function set forth above will be described in detail hereinafter. In the following, home appliances 200A-200F may also be generically referred to as home appliance 200.

<Hardware Configuration of Controller 100>

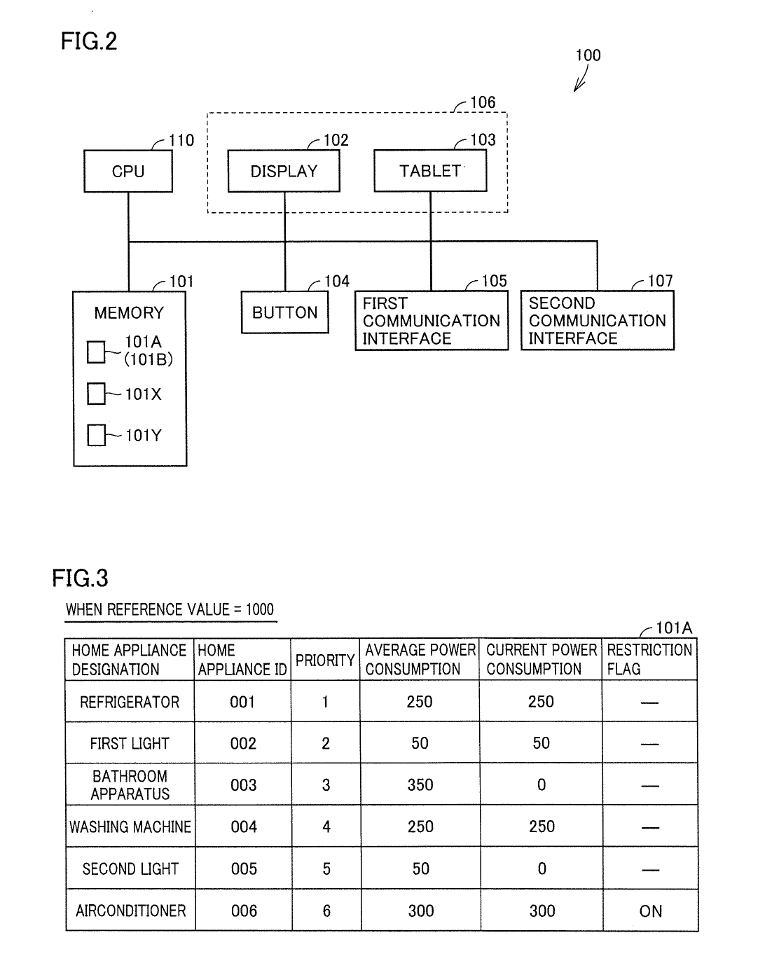

One aspect of a hardware configuration of controller 100 according to the present embodiment will be described. FIG. 2 is a block diagram representing a hardware configuration of controller 100 according to the present embodiment.

Controller 100 includes a memory 101, a display 102, a tablet 103, a button 104, a first communication interface 105, a second communication interface 107, and a CPU (Central Processing Unit) 110.

Memory 101 is implemented by various types of RAM (Random Access memory), ROM (Read-Only Memory), hard disk, and the like. For example, memory 101 may also be implemented by a medium or the like storing a program in a non-volatile manner such as an USB (Universal Serial Bus) memory, CD-ROM (Compact Disc-Read Only Memory), DVD-ROM (Digital Versatile Disk-Read Only Memory), USB (Universal Serial Bus) memory, memory card, FD (Flexible Disk), hard disk, magnetic tape, cassette tape, MO (Magnetic Optical Disc), MD (Mini Disc), IC (Integrated Circuit) card (excluding memory card), optical card, mask ROM, EPROM, EEPROM (Electronically Erasable Programmable Read-Only Memory) and the like, used through an interface for reading.

Memory 101 stores a control program executed by CPU 110, the state of home appliances 200A-200F, and the like. Memory 101 stores, when power failure occurs at the power grid, power control data 101A (power control table 101B in the modification) for controlling the operation of home appliances 200A-200F.

FIG. 3 is a pictorial representation of power control table 101A according to the present embodiment. Referring to FIG. 3, power control table 101A stores, for each of home appliances 200A-200F connected to controller 100, a home appliance ID, a priority level, average power consumption, current power consumption, and a restriction flag.

Home appliance ID is the information for identifying a home appliance.

The priority level is set for distributing the electric power from storage battery 300B. The probability is high for a high-priority home appliance, among home appliances 200A-200F, being supplied with electric power even in the event of power failure. In contrast, the probability is low for a low-priority home appliance, among home appliances 200A-200F, being supplied with electric power in the event of power failure.

The average power consumption is the average value of the amount of power consumption per unit time when in operation. For example, the average power consumption is calculated by CPU 110 obtaining the amount of power consumption per unit time from home appliances 200A-200F through first communication interface 105 at every predetermined period (for example, every day, every week, every month, every year, and the like).

The current power consumption is the value stored when power failure occurs at the power grid. CPU 110 obtains the amount of power consumption per unit time from home appliances 200A-200F when power failure occurs. Power control table 101A may store information indicating whether home appliances 200A-200F are currently used or not, instead of the current power consumption. In this case, when home appliances 200A-200F are currently used, CPU 110 employs the average power consumption of relevant home appliances 200A-200F as the current power consumption of home appliances 200A-200F. Also, CPU 110 estimates the current power consumption of home appliances 200A-200F not currently used as 0.

The restriction flag is on (flag=1) when power failure has occurred at the power grid and the operation of any of home appliances 200A-200F is to be restricted. In other words, when power failure has not occurred at the power grid, none of home appliances 200A-200F have the restriction flag on (flag=0). In contrast, when power failure has occurred at the power grid and when the remaining amount of storage battery 300B becomes lower than a predetermined value, the restriction flag corresponding to any of home appliances 200A-200F having a low priority level is rendered on (flag=1).

In the present embodiment, CPU 110 turns off the power supply of any of home appliances 200A-200F having a restriction flag on through first communication interface 105. The remaining ones of home appliances 200A-200F are operated as usual (as desired by the user).

CPU 110 may be configured to restrict the electric power to be used by any of home appliances 200A-200F having the restriction flag on to half through first communication interface 105. In this case, the amount of power consumption by all of home appliances 200A-200F must be restricted by increasing the number of home appliances having the restriction flag turned on. In other words, the number of home appliances not subjected to restriction will be reduced in such a case.

Returning to FIG. 2, memory 101 stores an average value 101X of the power consumption per unit time of the entire residence (the electric power used by all of home appliances 200A-200F). Memory 101 preferably stores average value 101X of the power consumption per unit time of the entire residence (the electric power used by all of home appliances 200A-200F) for every time zone. Memory 101 stores a power failure ending time 101Y obtained from server 500 or the user.

Display 102 shows the state of home appliances 200A-200F under control of

CPU 110. Tablet 103 detects a finger-touching operation by the user, and applies the touching coordinates or the like to CPU 110. CPU 110 accepts an instruction from the user through tablet 103.

In the present embodiment, tablet 103 is located on the surface of display 102. In other words, display 102 and tablet 103 constitute touch panel 106 in the present embodiment. However, controller 100 does not have to include tablet 103.

Button 104 is arranged at the surface of controller 100. A plurality of buttons such as the ten-key may be arranged at controller 100. Button 104 accepts various instructions from the user. Button 104 serves to apply an instruction from the user to CPU 110.

Under control of CPU 110, first communication interface 105 transmits and receives data through network 401 to and from home appliances 200A-200F, solar power generation device 300A, storage battery 300B, and power conditioner 300C. As mentioned above, first communication interface 105 transmits and receives data to and from home appliances 200A-200F by using a wired LAN, wireless LAN, PLC, Bluetooth (registered trademark) or the like.

Under control of CPU 110, second communication interface 107 transmits and receives data to and from server 500 through network 402. As mentioned above, second communication interface 107 transmits and receives data to and from server 500 by using the Internet, carrier network, WAN, LAN, Bluetooth (registered trademark) or the like.

First communication interface 105 and second communication interface 107 may be one communication interface (one device). Alternatively, first communication interface 105 and second communication interface 107 may conform to the same communication standard.

CPU 110 executes various programs stored in memory 101. The processing at controller 100 is implemented by each hardware and by software executed by CPU 110. Such software may be prestored in memory 101. The software may be stored in a storage medium and distributed as a program product. Alternatively, the software may be presented as a program product that can be downloaded by an information provider connected on the so-called Internet.

Such software is read out from the storage medium by utilizing a reader not shown. Alternatively, the software is downloaded by utilizing first communication interface 105 or second communication interface 107 to be temporarily stored in memory 101. CPU 110 has the software stored in memory 101 in the form of an executable program, and then executes the relevant program.

As the storage medium, a medium storing a program in a non-volatile manner such as a CD-ROM (Compact Disc-Read Only Memory) , DVD-ROM (Digital Versatile Disk-Read Only Memory), USB (Universal Serial Bus) memory, memory card, FD (Flexible Disk), hard disk, magnetic tape, cassette tape, MO (Magnetic Optical Disc), MD(Mini Disk), IC (Integrated Circuit) card (excluding memory card), optical card, mask ROM, EPROM and EEPROM (Electronically Erasable Programmable Read-Only Memory) can be cited.

As used herein, the program includes, not only a program that can be directly executed by the CPU, but also a program of a source program format, a compressed program, encrypted program, and the like.

<Control Processing of Controller 100>

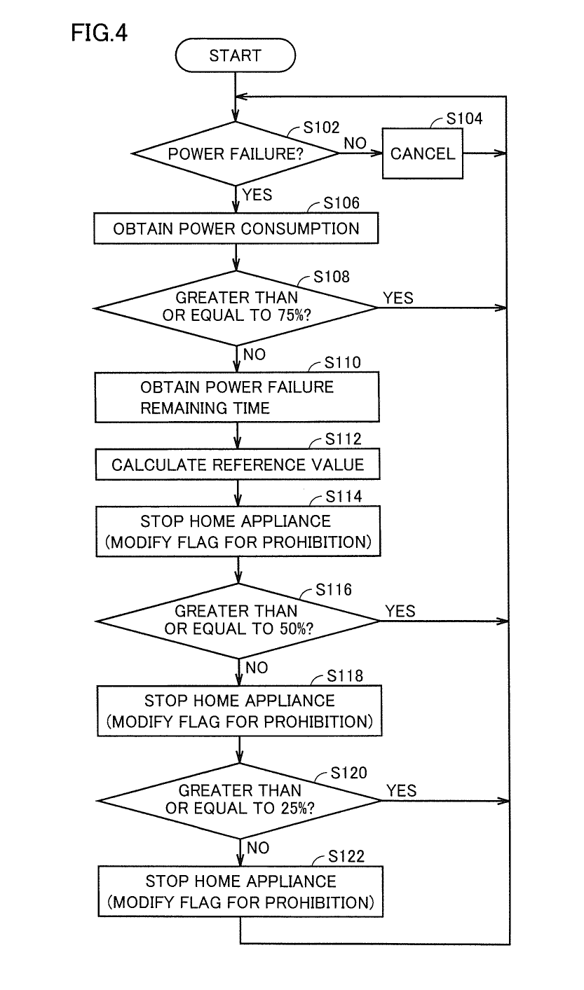

The power control processing at controller 100 according to the present embodiment will be described hereinafter. FIG. 4 is a flowchart of the procedure in the power control processing at controller 100 according to the present embodiment. In the event of power failure in the present embodiment, it is assumed that CPU 110 does not set the upper limit of power consumption in the case where the remaining amount in storage battery 300B is greater than or equal to 75% the capacity.

Referring to FIG. 4, CPU 110 determines whether information indicating that power failure has occurred at the power grid is received from power conditioner 300C through first communication interface 105 (step S102). When CPU 110 has not received information indicating that power failure has occurred at the power grid from power conditioner 300C (NO at step S102), all the restriction flags in power control table 101A are canceled (step S104). CPU 110 repeats the processing from step S102.

When information indicating that power failure has occurred at the power grid is received from power conditioner 300C (YES at step S102), CPU 110 obtains the current power consumption from each of home appliances 200A-200F through first communication interface 105 (step S106). CPU 110 stores the current power consumption into power control table 101A.

CPU 110 obtains the remaining amount in storage battery 300B from storage battery 300B through first communication interface 105. CPU 110 determines whether the remaining amount in storage battery 300B is greater than or equal to 75% the capacity (step S108). When the remaining amount in storage battery 300B is greater than or equal to 75% the capacity (YES at step S108), CPU 110 repeats the processing from step S102.

When the remaining amount in storage battery 300B is below 75% the capacity (NO at step S108), CPU 110 obtains the power failure ending time from server 500 through second communication interface 107 (step S110). In the present embodiment, CPU 110 calculates the power failure remaining time based on the power failure ending time from server 500 and the current time. CPU 110 may also obtain the power failure ending time from the user through button 104 or touch panel 106. CPU 110 calculates a reference value of power consumed by home appliances 200A-200F based on the remaining amount in storage battery 300B and the time before power failure ends. For example, in the present embodiment, CPU 110 solves the following equation to calculate the power control reference value, and periods T1, T2, and T3 of each stage of the remaining amount in storage battery 300B (step S112).

0.75*reference value*T1=remaining amount in storage battery (1)

0.5*reference value*T2=remaining amount in storage battery (2)

0.25*reference value*T3=remaining amount in storage battery (3)

T1+T2+T3=power failure remaining time (4)

CPU 110 refers to power control table 101A to control the operation of some of home appliances 200A-200F with 75% of the reference value as the upper limit of power consumption. Referring to FIG. 3, for example, consider the case where the reference value is 1000, and refrigerator 200A, first light 200B, washing machine 200D, and air conditioner 200F are operating. In this case, CPU 110 turns on the restriction flag for air conditioner 200F in power control table 101A.

When the determination is YES at step S116 that will be described afterwards, CPU 110 inserts 0 to T1 at step S112. When the determination is YES at step S120 that will be described afterwards, CPU 110 inserts 0 to T1 and T2 at step S112.

Returning to FIG. 4, the operation of air conditioner 200F is prohibited through first communication interface 105 (step S114). CPU 110 determines whether the remaining amount in storage battery 300B is greater than or equal to 50% the capacity (step S116). When the remaining amount in storage battery 300B is greater than or equal to 50% the capacity (YES at step S116), CPU 110 repeats the processing from step S102.

When the remaining amount in storage battery 300B is below 50% the capacity (NO at step S116), CPU 110 refers to power control table 101A to control the operation of some of home appliances 200A-200F with 50% of the reference value as the upper limit of power consumption. Referring to FIG. 5, for example, consider the case where reference value is 1000, and refrigerator 200A, first light 200B and washing machine 200D are operating. In this case, CPU 110 turns on the restriction flag for washing machine 200D, the restriction flag for second light 200E, and the restriction flag for air conditioner 200F in power control table 101A.

Returning to FIG. 4, CPU 110 prohibits the operation of washing machine 200D through first communication interface 105 (step S118). CPU 110 determines whether the remaining amount in storage battery 300B is greater than or equal to 25% the capacity (step S120). When the remaining amount in storage battery 300B is greater than or equal to 25% the capacity (YES at step S120), CPU 110 repeats the processing from step S102.

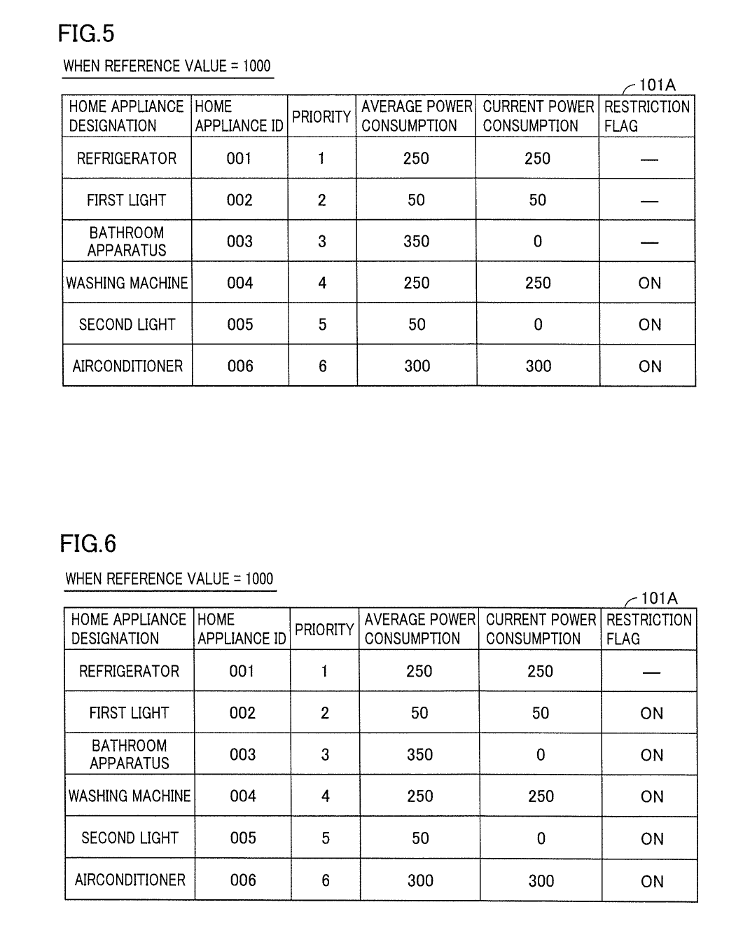

When the remaining amount in storage battery 300B is below 25% the capacity (NO at step S120), CPU 110 refers to power control table 101A to control the operation of some of home appliances 200A-200F with 25% of the reference value as the upper limit of power consumption. Referring to FIG. 6, for example, consider the case where the reference value is 1000, and refrigerator 200A and first light 200B are operating. In this case, CPU 110 turns on the restriction flag for first light 200B, the restriction flag for bathroom apparatus 200C, the restriction flag for washing machine 200D, the restriction flag for second light 200E, and the restriction flag for air conditioner 200F in power control table 101A.

Returning to FIG. 4, the operation of first light 200B is prohibited through first communication interface 105 (step S122). CPU 110 repeats the processing from step S102.

The present embodiment is based on the case where CPU 110 sets the reference value at step S112 when the remaining amount in storage battery 300B is below 75% the capacity. The present embodiment is not limited to such a scheme. The present embodiment may be implemented such that, only in the case where the remaining amount in storage battery 300B is below 25% the capacity, CPU 110 calculates the upper limit (150 W) of power consumption by dividing the remaining amount (for example, 300 Wh) by the power failure remaining time (for example, 2 hours) at step S112 or step S122.

In this case, when the remaining amount in storage battery 300B is greater than or equal to 25% and below 50% the capacity, CPU 110 may use a value that is the average value 101X of power consumption multiplied by a predetermined value (0.5) as the upper limit of power consumption (500 W) at step S112 or S118. In the case where the remaining amount in storage battery 300B is greater than or equal to 50% and below 100% the capacity, CPU 110 may use a value of average value 101X of power consumption multiplied by a predetermined value (0.75) as the upper limit of power consumption (750 W) at step 112 or step S114.

<Modification of Setting Restriction Flag >

In the present embodiment, a restriction flag in power control table 101A is turned on based on the current power consumption obtained from home appliances 200A-200F and the upper limit of power consumption. Alternatively, CPU 110 turns on a restriction flag in power control table 101A based on the information as to whether home appliances 200A-200F are operating or not, the average power consumption of home appliances 200A-200F, and the upper limit of power consumption.

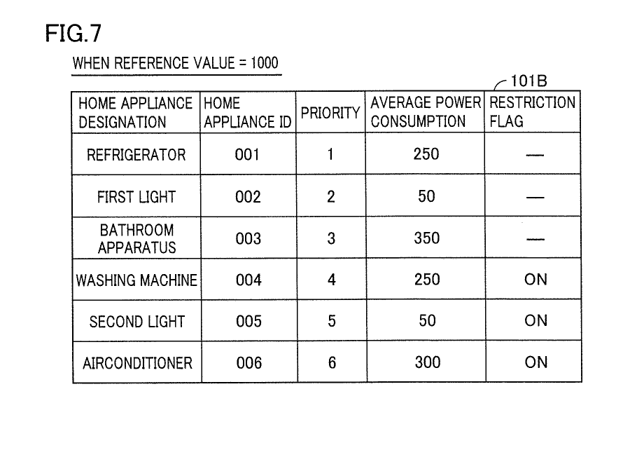

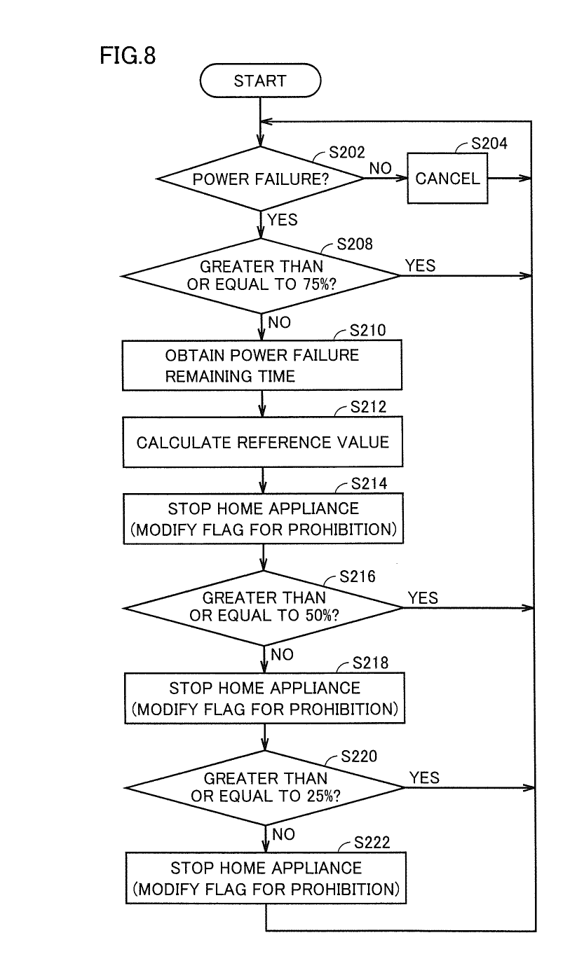

However, as will be described hereinafter, CPU 110 may turn a restriction flag on in a power control table 101B based on an upper limit of power consumption, independent of whether home appliances 200A-200F are operated or not. FIG. 7 is a pictorial representation of power control table 101B according to the present modification. FIG. 8 is a flowchart of the procedure in the power control processing at controller 100 of the present modification.

Referring to FIG. 8, CPU 110 determines whether information indicating that power failure has occurred at the power grid is received from power conditioner 300C through first communication interface 105 (step S202). When information indicating that power failure had occurred at the power grid is not received from power conditioner 300C (NO at step S202), CPU 110 cancels all the restriction flags in power control table 101B (step S204). CPU 110 repeats the processing from step S202.

When information indicating that power failure has occurred at the power grid is received from power conditioner 300C (YES at step S202), CPU 110 determines whether the remaining amount in storage battery 300B is greater than or equal to 75% the capacity (step S208). When the remaining amount in storage battery 300B is greater than or equal to 75% the capacity (YES at step 208), CPU 110 repeats the processing from step S202.

When the remaining amount in storage battery 300B is below 75% the capacity (NO at step S208), CPU 110 obtains from server 500 the power failure ending time through second communication interface (step S210). In the present embodiment, CPU 110 calculates the power failure remaining time based on the power failure ending time from server 500 and the current time. CPU 110 may obtain the power failure ending time from a user through button 104 or touch panel 106.

CPU 110 calculates a reference value of power consumed by home appliances 200A-200F and periods T1, T2, and T3 of each stage of the remaining amount in storage battery 300B (step S212) based on the remaining amount in storage battery 300B and the time before power failure ends. The method of calculating the reference value and periods T1, T2 and T3 is similar to those described according to FIG. 4. Therefore, description thereof will not be repeated.

CPU 110 refers to power control table 101B to control the operation of some of home appliances 200A-200F with 75% the reference value as the upper limit of power consumption. Referring to FIG. 7, for example, consider the case where the reference value is 1000. In this case, CPU 110 turns on the restriction flag for washing machine 200D, the restriction flag for second light 200E, and the restriction flag for air conditioner 200F in power control table 101B.

Returning to FIG. 8, the operation of washing machine 200D, second light 200E, and air conditioner 200F is prohibited through first communication interface 105 (step S214). CPU 110 determines whether the remaining amount in storage battery 300B is greater than or equal to 50% the capacity (step S216). When the remaining amount in storage battery 300B is greater than or equal to 50% the capacity (YES at step S216), CPU 110 repeats the processing from step S202.

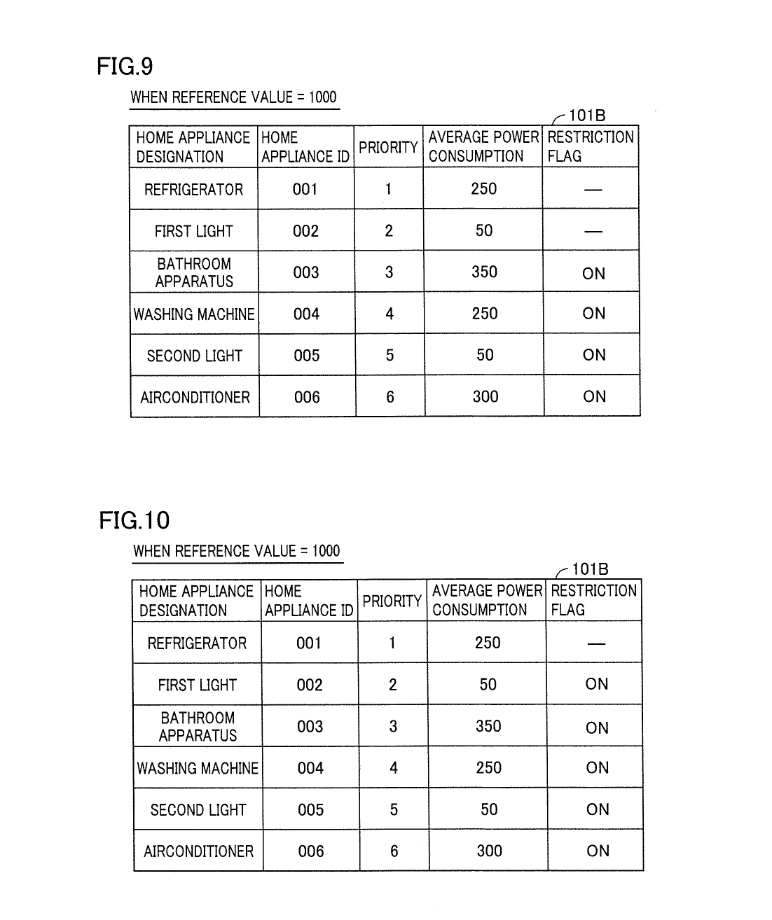

When the remaining amount in storage battery 300B is below 50% the capacity (NO at step S216), CPU 110 refers to power control table 101B to control the operation of some of home appliances 200A-200F with 50% the reference value as the upper limit of power consumption. Referring to FIG. 9, for example, consider the case where the reference value is 1000. CPU 110 turns on the restriction flag for bathroom apparatus 200C, the restriction flag for washing machine 200D, the restriction flag for second light 200E, and the restriction flag for air conditioner 200F in power control table 101B.

Returning to FIG. 8, CPU 110 prohibits the operation of bathroom apparatus 200C, washing machine 200D, second light 200E and air conditioner 200F through first communication interface 105 (step S218). CPU 110 determines whether the remaining amount in storage battery 300B is greater than or equal to 25% the capacity (step S220). When the remaining amount in storage battery 300B is greater than or equal to 25% the capacity (YES at step S220), CPU 110 repeats the processing from step S202.

When the remaining amount in storage battery 300B is below 25% the capacity (NO at step S220), CPU 110 refers to power control table 101B to control the operation of some of home appliances 200A-200F with 25% the reference value as the upper limit of power consumption. Referring to FIG. 10, for example, consider the case where the reference value is 1000, and refrigerator 200A and first light 200B are operating. In this case, CPU 110 turns on the restriction flag for first light 200B, the restriction flag for bathroom apparatus 200C, the restriction flag for washing machine 200D, the restriction flag for second light 200E, and the restriction flag for air conditioner 200F in power control table 101B.

Returning to FIG. 4, the operation of first light 200B, bathroom apparatus 200C, washing machine 200D, second light 200E, and air conditioner 200F is prohibited through first communication interface 105 (step S222). CPU 110 repeats the processing from step S202.

In the present modification, CPU 110 sets the reference value at steps S112 and S212 when the remaining amount in storage battery 300B is below 75% the capacity. However, the embodiment is not limited to such a scheme. For example, the embodiment may be implement such that, only when the remaining amount in storage battery 300B is below 25% the capacity, CPU 110 calculates the upper limit (150 W) of power consumption by dividing the remaining amount(for example 300 Wh) by the power failure remaining time (for example, 2 hours) at step S212 or step S222. In this case, when the remaining amount in storage battery 300B is greater than or equal to 25% and below 50% the capacity, CPU 110 may use a value of average value 101X of power consumption multiplied by a predetermined value (0.5) as the upper limit (500 W) of power consumption at step S212 or step S218. When the remaining amount in storage battery 300B is greater than or equal to 50% and below 100% the capacity, CPU 110 may employ a value of average value 101X of power consumption multiplied by a predetermined value (0.75) as the upper limit (750 W) of power consumption at step S212 or step S214.

In the present embodiment, storage battery 300B stores the electric power from solar power generation device 300A. However, the present invention is not limited to such an embodiment. For example, storage battery 300B may store electric power from another type of power generation device, may store electric power from a power grid to prepare for power failure at the power grid, or may store electric power from the power grid at a time zone when the cost of electric power from the power grid is low.

Although the present embodiment is directed to usage at a residence where home appliances 200A-200F are installed, the present invention is not limited to such an embodiment. For example, network system 1 is also applicable to hospitals, offices (or buildings), public facilities such as a school, or the like. By setting the priority level for supplying electric power to each electric appliance from storage battery 300B at the time of power failure in accordance with each environment, effective power control taking into consideration the power failure ending time is allowed.

At the time when solar power generation device 300A is generating power during the day time or when there are few persons at home, the reduction rate in the remaining amount in storage battery 300B is low. In contrast, when the power generator is not generating power and/or many persons are present at home, the reduction rate in the remaining amount in storage battery 300B is high. Network system 1 of the present embodiment can accommodate power failure more flexibly by taking into account the remaining amount in storage battery 300B

### Second Embodiment

A second embodiment of the present invention will be described hereinafter. Network system 1 according to the first embodiment set forth above is directed to having controller 100 set the upper limit of power consumption based on the power failure ending time from server 500 or the power failure ending time entered by the user. In the present embodiment, the operation of home appliances 200A-200F is restricted by controller 100 employing a plurality of predetermined upper limits of power consumption.

Any configuration similar to that of network system 1 of the first embodiment will not be described repeatedly. For example, the overall configuration of network system 1 in FIG. 1, power control tables 101A and 101B in FIGS. 3, 5, 6, 7, 9, and 10 are similar to those of the previous embodiment. Therefore, description thereof will not be repeated.

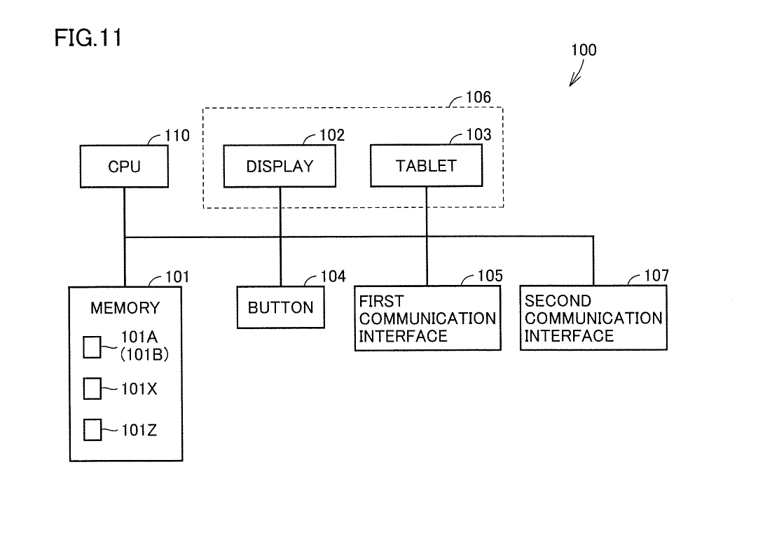

FIG. 11 is a block diagram representing a hardware configuration of controller 100 of the present embodiment. Referring to FIG. 11, memory 101 of the present embodiment stores an upper limit 101Z of power consumption at each stage of the remaining amount in storage battery 300B instead of power failure ending time 101Y.

For example, when the remaining amount in storage battery 300B is less than 25% the capacity, the upper limit of power consumption is 25% of average value 101X of the electric power used altogether at the residence. When the remaining amount in storage battery 300B is greater than or equal to 25% and below 50% the capacity, the upper limit of power consumption is 50% of average value 101X of the electric power used altogether at the residence. When the remaining amount in storage battery 300B is greater than or equal to 50% and below 75% the capacity, the upper limit of power consumption is 75% of average value 101X of the electric power used altogether at the residence. When the remaining amount in storage battery 300B is greater than or equal to 75% the capacity, the upper limit of power consumption is 75% of average value 101X of the electric power used altogether at the residence. Namely, the ratio of the second upper limit (50% electric power average value 101X) to the first upper limit (25% electric power average value 101X) is identical to the ratio of the second threshold value (50% the capacity) to the first threshold value (25% the capacity).

Alternatively, when the remaining amount in storage battery 300B is below 25% the capacity, the upper limit of power consumption is 5% of average value 101X of the electric power used altogether at the residence. When the remaining amount in storage battery 300B is greater than or equal to 25% and below 50% the capacity, the upper limit of power consumption is 15% of average value 101X of the electric power used altogether at the residence. When the remaining amount in storage battery 300B is greater than or equal to 75% the capacity, the upper limit of power consumption is 50% of average value 101X of the electric power used altogether at the residence. Namely, the ratio of the second upper limit (15% electric power average value 101X) to the first upper limit (5% electric power average value 101X) is greater than the ratio of the second threshold value (50% the capacity) to the first threshold value (25% the capacity).

The remaining elements of the hardware configuration of controller 100 are similar to those shown in FIG. 2. Therefore, description thereof will not be repeated.

<Power Control Processing at Controller 100>

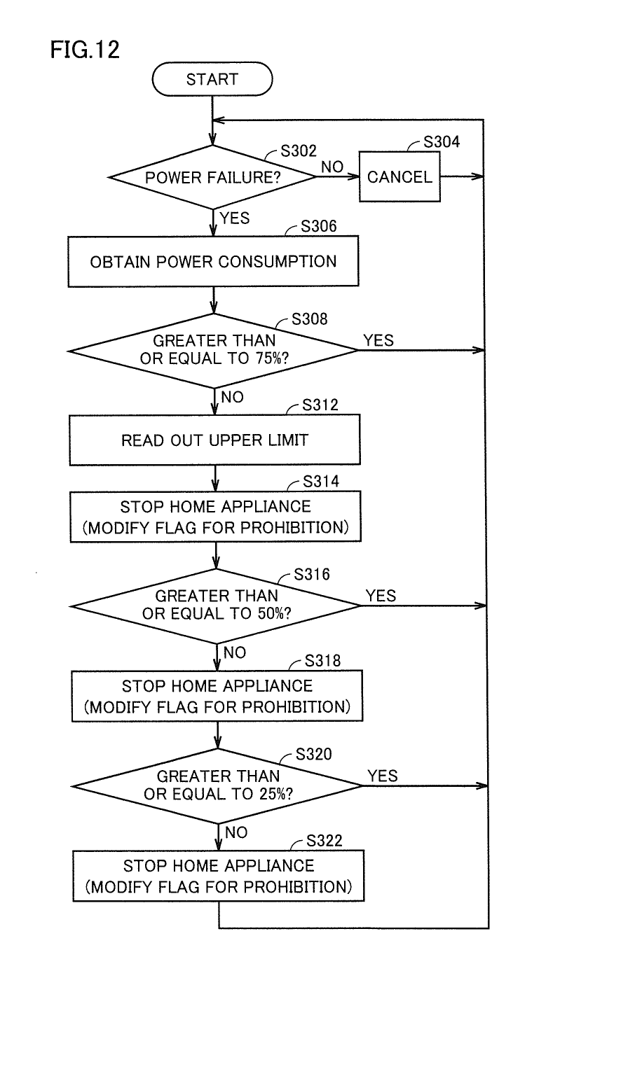

Power control processing at controller 100 according to the present embodiment will be described hereinafter. FIG. 12 is a flowchart of the procedure in the power control processing at controller 100 according to the present embodiment. Similarly in the present embodiment, it is assumed that CPU 110 does not set the upper limit of power consumption in the case where the remaining amount in storage battery 300B is greater than or equal to 75% the capacity.

Referring to FIG. 12, CPU 110 determines whether information indicating that power failure has occurred at the power grid is received from power conditioner 300C through first communication interface 105 (step S302). When CPU 110 has not received information indicating that power failure has occurred at the power grid from power conditioner 300C (NO at step S302), all the restriction flags in power control table 101A are canceled (step S304). CPU 110 repeats the processing from step S302. When information indicating that power failure has occurred at the power grid is received from power conditioner 300C (YES at step S302), CPU 110 obtains the current power consumption from each of home appliances 200A-200F through first communication interface 105 (step S306). CPU 110 stores the current power consumption into power control table 101A.

CPU 110 obtains the remaining amount in storage battery 300B from storage battery 300B through first communication interface 105. CPU 110 determines whether the remaining amount in storage battery 300B is greater than or equal to 75% the capacity (step S308). When the remaining amount in storage battery 300B is greater than or equal to 75% the capacity (YES at step S308), CPU 110 repeats the processing from step S302.

When the remaining amount in storage battery 300B is below 75% the capacity (NO at step S308), CPU 110 reads out the upper limit of power consumption at each stage of the remaining amount in storage battery 300B from memory 101.

CPU 110 controls the operation of some of home appliances 200A-200F based on the upper limit of power consumption. Referring to FIG. 3, for example, consider the case where the upper limit is 750, and refrigerator 200A, first light 200B, washing machine 200D, and air conditioner 200F are operating. In this case, CPU 110 turns on the restriction flag for air conditioner 200F in power control table 101A.

Returning to FIG. 12, the operation of air conditioner 200F is prohibited through first communication interface 105 (step S314). CPU 110 determines whether the remaining amount in storage battery 300B is greater than or equal to 50% the capacity (step S316). When the remaining amount in storage battery 300B is greater than or equal to 50% the capacity (YES at step S316), CPU 110 repeats the processing from step S302.

When the remaining amount in storage battery 300B is below 50% the capacity (NO at step S316), CPU 110 controls the operation of some of home appliances 200A-200F based on the upper limit of power consumption. Referring to FIG. 5, for example, consider the case where the upper limit is 500, and refrigerator 200A, first light 200B and washing machine 200D are operating. In this case, CPU 110 turns on the restriction flag for washing machine 200D, the restriction flag for second light 200E, and the restriction flag for air conditioner 200F in power control table 101A.

Returning to FIG. 12, CPU 110 prohibits the operation of washing machine 200D through first communication interface 105 (step S318). CPU 110 determines whether the remaining amount in storage battery 300B is greater than or equal to 25% the capacity (step S320). When the remaining amount in the storage battery 300B is greater than or equal to 25% the capacity (YES at step S320), CPU 110 repeats the processing from step S302.

When the remaining amount in storage battery 300B is below 25% the capacity (NO at step S320), CPU 110 controls the operation of some of home appliances 200A-200F based on the upper limit of power consumption. Referring to FIG. 6, for example, consider the case where the reference value is 1000, and refrigerator 200A and first light 200B are operating. In this case, CPU 110 turns on the restriction flag for first light 200B, the restriction flag for bathroom apparatus 200C, the restriction flag for washing machine 200D, the restriction flag for second light 200E, and the restriction flag for air conditioner 200F.

Returning to FIG. 12, operation of first light 200B is prohibited through first communication interface 105 (step S322). CPU 110 repeats the processing from step S302.

<Modification of Setting Restriction Flag>

Similarly in the present embodiment, CPU 110 turns on a restriction flag in power control table 101A based on the current power consumption obtained from home appliances 200A-200F and the upper limit of power consumption, as shown in FIGS. 3-6, likewise with the first embodiment. Alternatively, CPU 110 turns on a restriction flag in power control table 101A based on the information as to whether home appliances 200A-200F are operating or not, the average power consumption of home appliances 200A-200F, and the upper limit of power consumption.

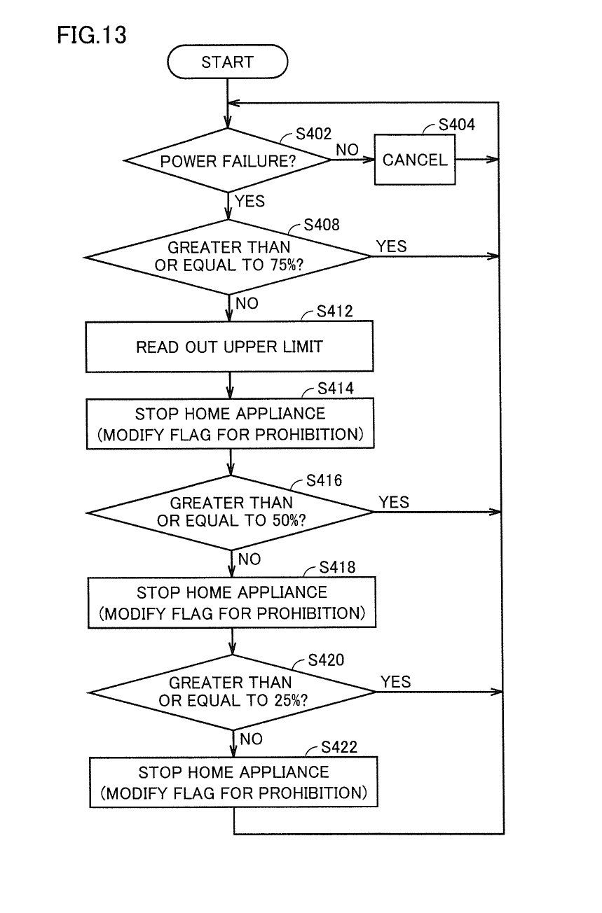

However, likewise with the modification in the first embodiment , CPU 110 may turn a restriction flag on in a power control table 101B based on an upper limit of power consumption, independent of whether home appliances 200A-200F are operated or not, as shown in FIGS. 7, 9, and 10. FIG. 13 is a flowchart of the procedure in the power control processing at controller 100 of the present modification.

Referring to FIG. 13, CPU 110 determines whether information indicating that power failure has occurred at the power grid is received from power conditioner 300C through first communication interface 105 (step S402). When information indicating that power failure had occurred at the power grid is not received from power conditioner 300C (NO at step S402), CPU 110 cancels all the restriction flags in power control table 101B (step S404). CPU 110 repeats the processing from step S402.

When information indicating that power failure has occurred at the power grid is received from power conditioner 300C (YES at step S402), CPU 110 determines whether the remaining amount in storage battery 300B is greater than or equal to 75% the capacity (step S408). When the remaining amount in storage battery 300B is greater than or equal to 75% the capacity (YES at step 408), CPU 110 repeats the processing from step S402.

When the remaining amount in storage battery 300B is below 75% the capacity (NO at step S408), CPU 110 reads out the upper limit of power consumption at each stage of the remaining amount in storage battery 300B from memory 101 (step S312).

CPU 110 controls the operation of some of home appliances 200A-200F based on the upper limit of power consumption. Referring to FIG. 7, for example, consider the case where the reference value is 1000. In this case, CPU 110 turns on the restriction flag for washing machine 200D, the restriction flag for second light 200E, and the restriction flag for air conditioner 200F in power control table 101B. Returning to FIG. 13, the operation of washing machine 200D, second light 200E, and air conditioner 200F is prohibited through first communication interface 105 (step S414). CPU 110 determines whether the remaining amount in storage battery 300B is greater than or equal to 50% the capacity (step S416). When the remaining amount in storage battery 300B is greater than or equal to 50% the capacity (YES at step S416), CPU 110 repeats the processing from step S402.

When the remaining amount in storage battery 300B is below 50% the capacity (NO at step S416), CPU 110 controls the operation of some of home appliances 200A-200F based on the upper limit of power consumption. Referring to FIG. 9, for example, consider the case where the reference value is 1000. In this case, CPU 110 turns on the restriction flag for bathroom apparatus 200C, the restriction flag for washing machine 200D, the restriction flag for second light 200E, and the restriction flag for air conditioner 200F in power control table 101B.

Returning to FIG. 13, CPU 110 prohibits the operation of bathroom apparatus 200C, washing machine 200D, second light 200E and air conditioner 200F through first communication interface 105 (step S418). CPU 110 determines whether the remaining amount in storage battery 300B is greater than or equal to 25% the capacity (step S420). When the remaining amount in storage battery 300B is greater than or equal to 25% the capacity (YES at step S410), CPU 110 repeats the processing from step S402.

When the remaining amount in storage battery 300B is below 25% the capacity (NO at step S420), CPU 110 controls the operation of some of home appliances 200A-200F based on the upper limit of power consumption. Referring to FIG. 10, for example, consider the case where the reference value is 1000. In this case, CPU 110 turns on the restriction flag for first light 200B, the restriction flag for bathroom apparatus 200C, the restriction flag for washing machine 200D, the restriction flag for second light 200E, and the restriction flag for air conditioner 200F in power control table 101B.

Returning to FIG. 13, the operation of first light 200B, bathroom apparatus 200C, washing machine 200D, second light 200E, and air conditioner 200F is prohibited through first communication interface 105 (step S422). CPU 110 repeats the processing from step S402.

In the present embodiment, storage battery 300B stores the electric power from solar power generation device 300A. However, the present invention is not limited to such an embodiment, as mention above. For example, storage battery 300B may store electric power from another type of power generation device, may store electric power from a power grid to prepare for power failure at the power grid, or may store electric power from the power grid at a time zone when the cost of electric power from the power grid is low.

Although the present embodiment is directed to usage at a residence where home appliances 200A-200F are installed, the present invention is not limited to such an embodiment. For example, network system 1 is also applicable to hospitals, offices (or buildings), public facilities such as a school, or the like. By setting the priority level for supplying electric power to each electric appliance from storage battery 300B at the time of power failure in accordance with each environment, power can be controlled in a stepped manner according to the remaining amount in storage battery 300B.

At the time when solar power generation device 300A is generating power during the day time or when there are only a few persons at home, the reduction rate in the remaining amount in storage battery 300B is low. In contrast, when the power generator is not generating power and/or many persons are present at home, the reduction rate in the remaining amount in storage battery 300B is high. Network system 1 of the present embodiment can accommodate power failure more flexibly by taking into account the remaining amount in storage battery 300B.

### Other Embodiments

It is needless to say that the present invention is also applicable to the case that can be achieved by supplying a program to a home controller, home appliance, or cellular phone. Then, the storage medium storing a program represented by software directed to achieving the present invention is supplied to a system or device. The computer (or CPU or MPU) of that system or device reads out and executes the program codes stored in the storage medium, allowing the advantage of the present invention to be presented.

In this case, the program codes per se read out from the storage medium will realize the aforementioned functions of the embodiments set forth above, and the storage medium storing the program codes will constitute the present invention.

In addition to realizing the functions of the embodiments set forth above by executing program codes read out by a computer, the present invention includes the case where the functions of the embodiments described above are realized by a process according to an OS (operating system) running on the computer performing a part of or all of the actual process based on the commands of the relevant program codes.

Further, the program codes read out from the storage medium may be written to a memory included in a functionality expansion board inserted to a computer or a functionality expansion unit connected to a computer. Then, the functions of the embodiments described above may be realized by a process according to a CPU or the like provided on the functionality expansion board or the functionality expansion unit, performing a part of or all of the actual process, based on the commands of the relevant program codes.

It is to be understood that the embodiments disclosed herein are only by way of example, and not to be taken by way of limitation. The scope of the present invention is not limited by the description above, but rather by the terms of the appended claims, and is intended to include any modifications within the scope and meaning equivalent to the terms of the claims.

### REFERENCE SIGNS LIST

1 network system; 100 controller; 101 memory; 101A, 101B power control table; 101X average value of power consumption; 101Y ending time ; 101Z upper limit; 102 display; 103 tablet; 104 button; 105 first communication interface; 106 touch panel; 107 second communication interface; 110 CPU; 200, 200A-200F electric appliance (home appliance); 300A solar power generation device; 300B storage battery; 300C power conditioner; 401 first network; 402 second network; 500 server.

1-9. (canceled)

10. A power control network system comprising:
a storage battery;
a plurality of electric appliances for operating by utilizing electric power from at least one of a power grid and said storage battery; and
a controller,
said controller including:
a communication interface for communicating with said storage battery and said plurality of electric appliances; and
a processor,
said processor configured to:
obtain, when power failure occurs at said power grid, information related to an operating state of said plurality of electrical appliances;
determine whether a remaining amount in said storage battery is below a first threshold value, and whether the remaining amount in said storage battery is greater than or equal to said first threshold value and less than a second threshold value that is larger than said first threshold value;
restrict an operation of at least some of electrical appliances in operation among said plurality of electrical appliances through said communication interface, such that power consumption of said plurality of electric appliances does not exceed a predetermined first upper limit during a period in which the remaining amount in said storage battery is below said first threshold value; and
restrict an operation of at least some of electrical appliances in operation among said plurality of electrical appliances through said communication interface, such that power consumption of said plurality of electric appliances does not exceed a predetermined second upper limit during a period in which the remaining amount in said storage battery is greater than or equal to said first threshold value and below a second threshold value that is larger than said first threshold value.

11. The power control network system according to claim 10, wherein a ratio of said second upper limit to said first upper limit is identical to the ratio of said second threshold value to said first threshold value.

12. The power control network system according to claim 10, wherein a ratio of said second upper limit to said first upper limit is greater than the ratio of said second threshold value to said first threshold value.

13. The power control network system according to claim 10, wherein restricting an operation of at least some of electrical appliances in operation among said plurality of electrical appliances includes restricting a part of a function of at least one electrical appliance in operation among said plurality of electric appliances.

14. The power control network system according to claim 10, wherein said processor configured to:
obtain, when power failure occurs at said power grid, a time when the power failure ends;
calculate, when a remaining amount in said storage battery is below said first threshold value, a first upper limit of power consumption of said plurality of electric appliances during a period in which the remaining amount in said storage battery is below said first threshold value such that said storage battery is not depleted before the time when said power failure ends; and
restrict an operation of at least some of said plurality of electric appliances through said communication interface such that power consumption of said plurality of electric appliances does not exceed said first upper limit during a period in which the remaining amount in said storage battery is below said first threshold value.

15. The power control network system according to claim 14, wherein
said processor is configured to:
calculate, when the remaining amount in said storage battery is greater than or equal to said first threshold value and below said second threshold value, a second upper limit of power consumption of said plurality of electric appliances during a period in which the remaining amount in said storage battery is greater than or equal to said first threshold value and below said second threshold value, such that said storage battery is depleted only after the time when power failure ends; and
restrict an operation of at least some of said plurality of electric appliances through said communication interface such that power consumption of said plurality of electric appliances does not exceed said second upper limit during a period in which the remaining amount in said storage battery is greater than or equal to said first threshold value and below said second threshold value that is larger than said first threshold value,
said second threshold value has a predetermined ratio to said first threshold value.

16. The power control network system according to claim 14, wherein said processor is configured to receive, through said communication interface, the time when said power failure ends from an external server.

17. The power control network system according to claim 14, wherein
said controller further includes an operation unit for accepting information from a user,
said processor is configured to accept the time when power failure ends through said operation unit.

18. The power control network system according to claim 10, wherein said processor is configured to restrict, based on a predetermined priority level, the operation of at least some of said plurality of electric appliances by prohibiting in order the operation of an electric appliance having a lower priority level through said communication interface.

19. The power control network system according to claim 10, further comprising a solar power generation device,
wherein said storage battery stores electric power from said solar power generation device.

20. A power control method at a network system including a storage battery, a plurality of electric appliances for operating by utilizing electric power from at least one of a power grid and said storage battery, and a controller, said method comprising:
obtaining, by said controller, when power failure occurs at said power grid, information related to an operating state of said plurality of electrical appliances;
determining, by said controller, whether a remaining amount in said storage battery is below a first threshold value, and whether the remaining amount in said storage battery is greater than or equal to said first threshold value and below a second threshold value that is larger than said first threshold value;
restricting, by said controller, an operation of at least some of electrical appliances in operation among said plurality of electrical appliances, such that power consumption of said plurality of electric appliances does not exceed a predetermined first upper limit during a period in which the remaining amount in said storage battery is below said first threshold value; and
restricting, by said controller, an operation of at least some of electrical appliances in operation among said plurality of electrical appliances, such that power consumption of said plurality of electric appliances does not exceed a predetermined second upper limit during a period in which the remaining amount in said storage battery is greater than or equal to said first threshold value and below a second threshold value that is larger than said first threshold value.

21. A power controller comprising:
a communication interface for communicating with a storage battery, and a plurality of electric appliances for operating by utilizing electric power from at least one of a power grid and said storage battery; and
a processor;
said processor configured to:
obtain, when power failure occurs at said power grid, information related to an operating state of said plurality of electrical appliances;
determine whether a remaining amount in said storage battery is below a first threshold value, and whether the remaining amount in said storage battery is greater than or equal to said first threshold value and below a second threshold value that is larger than said first threshold value;
restrict an operation of at least some of electrical appliances in operation among said plurality of electrical appliances through said communication interface, such that power consumption of said plurality of electric appliances does not exceed a predetermined first upper limit during a period in which the remaining amount in said storage battery is below said first threshold value; and
restrict an operation of at least some of electrical appliances in operation among said plurality of electrical appliances through said communication interface, such that power consumption of said plurality of electric appliances does not exceed a predetermined second upper limit during a period in which the remaining amount in said storage battery is greater than or equal to said first threshold value and below a second threshold value that is larger than said first threshold value.
